(19) United States
(12) Patent Application Publication
(10) Pub. No.: US 2008/0226952 A1
(43) Pub. Date: Sep. 18, 2008

(54) PROCESSES FOR ACTIVATING MEMBRANE ELECTRODE ASSEMBLIES

(75) Inventors: Hanwei Lei, Albuquerque, NM (US); Paolina Atanassova, Albuquerque, NM (US); Ryan C. Wall, Albuquerque, NM (US)

Correspondence Address: Jaimes Sher, Esq.;Cabot Corporation, 5401 Venice Avenue NE, Albuquerque, NM, 87113, US

(73) Assignee: Cabot Corporation, Boston, MA (US)

(21) Appl. No.: 11/687,293

(22) Filed: Mar. 16, 2007

(51) Int. Cl. H01M 8/00

(52) U.S. Cl. 429/13

(57) ABSTRACT

A process for the activation of a membrane electrode assembly, such as a direct methanol fuel cell membrane electrode assembly, with a hydrocarbon fuel, e.g., an alkanol fuel such as methanol, and an oxidant is described. The process comprises repeatedly applying an increasing or decreasing potential in each of a plurality of cycles over a voltage range of at least 0.1 volts, e.g., at least 0.2 volts or at least 0.3 volts, until the membrane electrode assembly is substantially activated. The cycles optionally are organized in cycle sets with rest periods therebetween. The temperature at which the cycles are run optionally is increased or decreased in a respective cycle set.

### BACKGROUND OF THE INVENTION

1. Field of the Invention

The present invention relates to membrane electrode assemblies. In particular, the invention relates to processes for activating membrane electrode assemblies.

2. Discussion of Background Information

The production of sufficient electrical power to meet the needs of a growing population and economy is a constant challenge. In view of limitations on traditional electric power production, there is increased interest in alternative means of producing electricity.

One technology that has evoked increasing interest in the area of alternate energy sources in recent years is the fuel cell. Fuel cells are devices that generate electricity directly from chemical energy. Fuel cells are structurally comprised of a series of membrane electrode assemblies (MEA's) electrically connected in series to one another. Each MEA comprises an anode, a cathode, and an electrolyte disposed between the anode and cathode. In operation, fuel cells operate in a manner similar to batteries. Unlike batteries, however, fuel cells are supplied with a continuous stream of fuel and oxidant. The fuel is supplied to the anode, and the oxidant is supplied to the cathode. The fuel and oxidant are electrochemically combined, thus releasing electrical energy, which is available for use.

The mechanism of energy production seen in fuel cells sets them apart from other energy production technologies in that it provides a very efficient, clean, and quiet source of energy. Specifically, since fuel cells effectively convert chemical energy to electricity, without the intermediate steps of conversion to heat and subsequent conversion to mechanical energy common to most energy production methods, efficiency can be increased. Further, since no combustion takes place in the energy conversion process in a fuel cell, the chemical products of the fuel cell can be more accurately predicted and carefully chosen. Indeed, in many fuel cell designs, the main product of the reaction is water vapor. Accordingly, fuel cells also provide significant environmental benefits over conventional electric power production devices.

One problem associated with fuel cells, and particular, with MEA's, is that they typically must be activated prior to use. The purpose of MEA activation, also referred to as conditioning or break-in, is to properly hydrate the membrane and develop optimal electrode structures in the MEA so as to maximize the MEA's ability to convert reactants (fuel and an oxidant) to products and produce electricity. Additionally, MEA conditioning is believed to reduce surface oxides on the electrocatalyst that is employed and thereby render the electrocatalyst more active.

One conventional process for activating an MEA comprises feeding hydrogen fuel and air to the MEA while applying a potential to the MEA that is pulsed between two different voltages. This process has been employed to activate both hydrogen/air fuel cell MEA's and direct methanol fuel cell (DMFC) MEA's. This process may be undesirable because the explosiveness of hydrogen may pose a safety hazard. This danger is exasperated in DMFC MEA's, which are not designed for receiving gaseous reactants on the anode side potentially leading to dangerous hydrogen leakage from the MEA during activation. In addition, a hydrogen source might not be readily available when desired for proper activation, particularly for DMFC activation. Accordingly, the need exists for fuel cell activation processes that do not employ hydrogen.

Another process for activating an MEA, and in particular a DMFC MEA, comprises feeding methanol and air to the MEA under static conditions, i.e., while applying a constant potential and while operating at a constant temperature. This process requires extremely long periods of time to reach full activation, e.g., on the order of two days or longer, during which the fuel cell is not operating in its fully activated state. Thus, the need also exists for fuel cell activation processes that are capable of achieving substantial activation of fuel cells more quickly than conventional activation processes.

### SUMMARY OF THE INVENTION

The present invention provides processes for activating fuel cells, e.g., direct methanol fuel cells (DMFC's). In one aspect, the invention provides a process for activating a membrane electrode assembly, comprising repeatedly applying an increasing or decreasing potential in each of a plurality of cycles over a voltage range of at least 0.1 volts, e.g., at least 0.2 volts, at least 0.3 volts, at least 0.4 volts, or 0.5 volts, while feeding a hydrocarbon fuel, e.g., an alkanol fuel such as methanol, and an oxidant to the membrane electrode assembly until the membrane electrode assembly is substantially activated.

In another embodiment, the invention is to a process for activating a membrane electrode assembly, comprising repeatedly applying an increasing or decreasing potential in each of a plurality of cycles over a voltage range of at least 0.1 volts, e.g., at least 0.2 volts, at least 0.3 volts, at least 0.4 volts, or 0.5 volts, until the membrane electrode assembly is substantially activated, wherein at least two of the plurality of cycles are separated by a rest period of less than 10 hours.

In another embodiment, the invention is to a process for activating a membrane electrode assembly, comprising repeatedly applying an increasing or decreasing potential in each of a plurality of cycles over a voltage range of at least 0.1 volts, e.g., at least 0.2 volts, at least 0.3 volts, at least 0.4 volts, or 0.5 volts, until the membrane electrode assembly is substantially activated, wherein the cycles are organized in a plurality of cycle sets separated by an average rest period of less than about 24 hours.

Optionally, in the various embodiments, the plurality of cycles is organized in a plurality of cycle sets, e.g., from about 5 cycle sets to about 11 cycle sets, or from about 7 cycle sets to about 9 cycle sets. The plurality of cycle sets optionally has an average number of cycles per cycle set of from about 2 to about 4. Optionally, at least one cycle set has an increasing or decreasing temperature profile for each respective cycle in the at least one cycle set.

Preferably, the membrane electrode assembly is substantially activated in less than about 48 hours or less than about 24 hours. Additionally or alternatively, the process provides an increase in activation of greater than about 20%, e.g., greater than 100%, after less than about 20 hours.

### BRIEF DESCRIPTION OF THE DRAWINGS

The present invention will be better understood in view of the following non-limiting figures, wherein:

FIG. 1 is a simplified block diagram of a direct methanol fuel cell (DMFC) membrane electrode assembly (MEA);

FIG. 2 is a plot of voltage and power density as a function of current density after activation of a DMFC MEA with hydrogen gas and air;

FIG. 3 is a bar graph showing the power densities at 0.45 volts of an MEA activated with hydrogen gas and air;

FIG. 4 is a plot of voltage and power density as a function of current density after activation of a DMFC MEA with methanol and air according to one embodiment of the present invention;

FIG. 5 is a bar graph showing the power densities at 0.45 volts of a DMFC MEA that has been activated with methanol and air according to one embodiment of the present invention;

FIG. 6 is a plot of voltage and power density as a function of current density after activation of a DMFC MEA with methanol and air according to one embodiment of the present invention;

FIG. 7 is a bar graph showing the power densities at 0.45 volts of a DMFC MEA that has been activated with methanol and air according to one embodiment of the present invention;

FIG. 8 is a plot of voltage and power density as a function of current density after activation of a DMFC MEA with methanol and air according to one embodiment of the present invention; and

FIG. 9 is a bar graph showing the power densities at 0.45 volts of a DMFC MEA that has been activated with methanol and air according to one embodiment of the present invention.

### DETAILED DESCRIPTION OF THE PRESENT INVENTION

The various features of the preferred embodiment(s) will now be described with reference to the drawing figures, in which like parts are identified with the same reference characters. The following description of the presently contemplated embodiments of practicing the invention are not to be taken in a limiting sense, but are provided merely for the purpose of describing the general principles of the invention.

### I. Introduction

The present invention is directed to processes for activating fuel cell membrane electrode assembly (MEA). A variety of types of fuel cell MEA's can be activated using the processes of the present invention. One example of an MEA that can be activated using the process of the present invention is a direct methanol fuel cell (DMFC) MEA. A DMFC is a type of solid polymer electrolyte (SPE) fuel cell. A SPE fuel cell typically employs a proton exchange polymer membrane that serves as a physical separator between the anode and cathode while also serving as an electrolyte. In fuel cells, the solid polymer electrolyte membrane typically comprises a perfluorinated sulfonic acid polymer membrane in acid form. Such fuel cells are often referred to as proton exchange membrane or polymer electrolyte membrane (PEM) fuel cells. The membrane is disposed between and in contact with the anode and the cathode. Electrocatalysts in the anode and the cathode typically induce the desired electrochemical reactions and may comprise, for example, a metal black, an alloy and/or a metal catalyst supported on a substrate, e.g., platinum on carbon. SPE fuel cells typically also comprise porous, electrically conductive sheet materials that are in electrical contact with the electrodes, and which permit diffusion of the reactants to the electrodes. The conductive sheet materials may comprise, for example, a porous, conductive sheet material such as carbon fiber paper or carbon cloth. An assembly comprising a membrane, anode and cathode, and diffusion layers for each electrode, is sometimes referred to as a membrane electrode assembly (MEA). Bipolar plates, made of a conductive material and providing flow fields for the reactants, are placed between a number of adjacent MEA's. A number of MEA's and bipolar plates are assembled in this manner to provide a fuel cell stack.

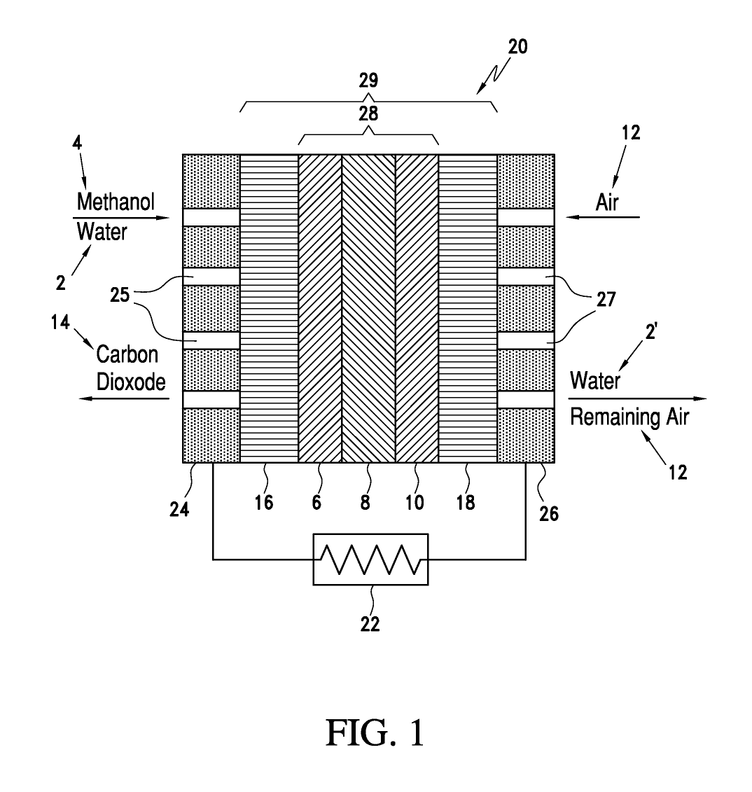

To appreciate the utility of the present invention, it is important to understand the structure and functionality of a DMFC. FIG. 1 is a simplified diagram of a DMFC 20 (not to scale) that comprises an MEA 29. As shown, MEA 29 comprises a catalyst coated membrane (CCM) 28 and two diffusion layers 16, 18 disposed on the opposite sides thereof, respectively. Bipolar plates 24 and 26 are disposed between the anode and cathode of sequential MEA stacks and comprise current collectors and flow fields, 25 and 27, for directing the flow of incoming reactant fluid to the appropriate electrode. Two end plates (not shown), similar to the bipolar plates, are used to complete the fuel cell stack. CCM 28 comprises an electrolytic membrane 8 (e.g., PEM membrane) having opposing major planar surfaces and catalyst layers disposed on each of the opposing major planar surfaces.

As shown in FIG. 1, during operation, a fuel comprising methanol 4 in solution with water 2 is fed to the anode 6 side of the MEA. The solution of methanol 4 and water 2 is applied to anode 6 through bipolar plate 24 and liquid diffusion layer (LDL) 16, which is designed to spread methanol 4 across anode 6 as evenly and completely as possible. As the methanol 4 is oxidized at anode 6, carbon dioxide 14 is formed, which is efficiently and effectively channeled through LDL 16 and bipolar plate 24 and liberated to the environment. Protons, which are also formed in the oxidation reaction, are then transported (typically as hydronium ions) through the electrolytic membrane 8 to cathode 10, where the previously stripped electrons, having completed the path through external load/circuit 22, rejoin and react with oxygen from air (or another oxidant such as hydrogen peroxide) 12, to form water 2′, which is then carried away from the fuel cell with any remaining air via gas diffusion layer (GDL) 18 and bipolar plate 26. GDL 18 is designed to efficiently and effectively channel water away (as water vapor) that forms at cathode 10, along with any remaining air 12. DMFCs and their operation are further described in pending U.S. patent application Ser. No. 10/417,417, filed Apr. 16, 2003 (Publ. No. US 2004/0038808 A1), the entirety of which is incorporated herein by reference.

In order for a fuel cell, and in particular a DMFC, to operate efficiently as described above, the MEA should be properly hydrated. Maintaining proper MEA hydration levels is important, for example, to maximize proton transport through the electrolytic membrane. New MEA's and MEA's that have been inoperative for extended periods of time are typically not properly hydrated for efficient operation. Accordingly, it is normally necessary to activate, e.g., condition or break-in, such MEA's prior to use. MEA activation is a process whereby the conditions in the MEA are readied for continuous MEA operation. Conventional activation processes for DMFC's typically comprise sending a hydrogen fuel to the MEA for a period of time, optionally while pulsing the MEA between two potentials or holding the MEA at one voltage for an extended period of time. Such processes are generally undesirable for a variety of reasons. For example, the explosiveness of hydrogen may pose a safety hazard, particularly since DMFC MEA's are not designed to received gaseous reactants at the anode side possibly resulting in hydrogen leakage during activation. In addition, a hydrogen source might not be readily available when desired for activation. Accordingly, the need exists for MEA activation processes that do not employ hydrogen.

Another process for activating an MEA, and in particular a DMFC MEA, comprises feeding methanol and air to the MEA under static conditions, i.e., while applying a constant potential and while operating at a constant temperature. As indicated above, this process requires extremely long periods of time to reach full activation, e.g., on the order of two days or longer, during which the MEA is not operating in its fully activated state. Thus, the need also exists for MEA activation processes that are capable of achieving substantial activation of MEA's more quickly than conventional activation processes.

In various embodiments, the present invention provides activation processes that desirably employ safe non-explosive hydrocarbon (e.g., alkanol) fuels rather than hydrogen. In addition, in various embodiments, the processes of the present invention are capable of activating MEA's, such as DMFC MEA's, more quickly than conventional activation processes.

### II. MEA Activation Processes

In a first embodiment, the invention is directed to a process for activating an MEA, preferably a DMFC MEA, with a hydrocarbon (e.g., alkanol) fuel. In this aspect, the process comprises repeatedly applying an increasing or decreasing potential (including optionally applying an increasing and decreasing potential) in each of a plurality of cycles over a voltage range of at least 0.1 volts, e.g., at least 0.2 volts or at least 0.3 volts, while feeding the hydrocarbon (e.g., alkanol) fuel and an oxidant to the MEA until the MEA is substantially activated. By employing a hydrocarbon fuel, substantial activation of MEA's desirably may be achieved without the concomitant engineering and safety concerns associated with conventional hydrogen activation processes.

In a second embodiment, the invention is directed to a process for activating an MEA, preferably a DMFC MEA, comprising repeatedly applying an increasing or decreasing potential in each of a plurality of cycles over a voltage range of at least at least 0.1 volts, e.g., at least 0.2 volts or at least 0.3 volts, until the MEA is substantially activated. In this aspect, at least two of the plurality of cycles are separated by a rest period of less than 10 hours, e.g., less than 7 hours, less than 5 hours, less than 3 hours or less than 2 hours, but preferably greater than 15 minutes, greater than 30 minutes or greater than 1 hour. In this context, the term “rest period” means a period of time in which a potential is not being applied to the MEA. Surprisingly and unexpectedly and contrary to conventional thinking, it has now been discovered that substantial MEA activation may be achieved without extended rest periods between cycles. By employing shorter rest periods, the time required for the overall activation process may be appreciably reduced.

In a third embodiment, the invention is directed to a process for activating an MEA, preferably a DMFC MEA, in a series of cycle sets that are separated by an average rest period of less than about 10 hours, e.g., less than about 7 hours, less than about 5 hours or less than about 3 hours, but preferably greater than 15 minutes, greater than 30 minutes or greater than 1 hour. In this context, the term “cycle set” means a plurality of sequential cycles that are not separated by any appreciable rest period (e.g., are not separated by a rest period of more than about 5 minutes). In this aspect, the process comprises the step of repeatedly applying an increasing or decreasing potential in each of a plurality of cycles over a voltage range of at least 0.1 volts, e.g., at least 0.2 volts or at least 0.3 volts, until the MEA is substantially activated, wherein the cycles are organized in a plurality of cycle sets separated by an average rest period of less than about 10 hours, e.g., less than about 7 hours, less than about 5 hours, or less than about 3 hours, but preferably greater than 15 minutes, greater than 30 minutes or greater than 1 hour. By employing cycle sets coupled with short rest periods between the cycle sets, it has been surprisingly and unexpectedly discovered that the overall time required to achieve substantial activation of MEA's may be appreciably reduced relative to conventional activation processes.

The above-described processes of the present invention may be modified, possibly significantly modified, depending, for example, on the type of MEA being hydrated and on the hydration level and prior conditioning (if any) of the MEA at the beginning of the activation process. For example, MEA's that have been previously activated, but which have been inoperative for an extended period of time, would typically require less activation time than MEA's that have not be previously activated, e.g., “new” MEA's. Various preferred modifications to the above-described processes are described below. Of course, as one skilled in the art would recognize, additional modifications to the inventive processes may also be realized without departing from the spirit and scope of the present invention.

Prior to activation of an MEA according to the processes of the present invention, the MEA is connected to an apparatus that is able to apply a voltage to the MEA that can be held constant or can be varied, as desired (e.g., pulsed, increased or decreased, whether smoothly or in discrete steps). Connecting of the MEA to such an apparatus will allow for one to repeatedly apply a constant and/or increasing and/or decreasing potential to the MEA, over a voltage range, as desired, repeatedly until the MEA is substantially activated. During the activation processes of the present invention, the MEA is preferably provided with a hydrocarbon (e.g., alkanol) fuel and an oxidant, e.g., air, during the application of the increasing or decreasing potential. The oxidant preferably comprises a gas such as air, oxygen or any suitable gas or agent that can be reduced at the cathode by the electrons that are produced via the oxidation of the hydrocarbon fuel at the anode during the activation process, and which are transferred through the electrolytic membrane. Alternatively, a liquid oxidant, e.g., hydrogen peroxide, may be employed. Importantly, the processes of the present invention do not require feeding the oxidant to the MEA at increased pressures. For example, the gaseous oxidant, e.g., air, may be fed to the MEA at a pressure less than about 800 torr, preferably at about 1 atmosphere (about 760 torr). Additionally, the processes of the present invention do not require feeding humidified gaseous oxidant to the MEA. Accordingly, the process optionally does not include either a step of humidifying air (or other gaseous oxidant) and/or prior to feeding the air to the MEA. In various optional embodiments, the process comprises feeding air to the MEA, wherein the air has a relative humidity of less than about 50%, e.g., less than about 40%, less than about 30%, less than about 20% or less than about 10%. As used herein, a “hydrocarbon” comprises any C₁-C₆ branched or unbranched hydrocarbon. Similarly, as used herein, an “alkanol” comprises any C₁-C₆ branched or unbranched alcohol. In some embodiments, the alkanol fuel comprises alcohols selected from the group consisting of methanol, ethanol, propanol, butanol and pentanol. In a preferred embodiment, the alkanol fuel comprises methanol.

The concentration of the methanol may vary widely. For example, in one aspect, the methanol concentration ranges from about 0.1 to about 15 M, e.g., from about 0.3 to about 12 M, from about 1 to about 10 M or from about 3 to about 5 M.

As indicated above, various embodiments of the present invention include a step of repeatedly applying an increasing or decreasing potential in each of a plurality of cycles over a voltage range of at least 0.1 volts, e.g., at least 0.2 volts or at least 0.3 volts. That is, the MEA is repeatedly cycled through an increasing or decreasing potential. In various embodiments, the application of the increasing or decreasing potential is over a voltage range of at least 0.4 volts, e.g., at least 0.5 volts, at least 0.6 volts or at least 0.7 volts.

Each respective cycle begins at a starting potential and ends at an ending potential. In one aspect, the step of repeatedly applying an increasing or decreasing potential comprises repeatedly applying a decreasing potential. In this aspect, the starting potential for at least one cycle or the average starting potential for all of the cycles preferably is from about 0.4 volts to about 0.9 volts, e.g., from about 0.5 volts to about 0.8 volts, from about 0.6 volts to about 0.8 volts, or about 0.7 volts. Preferably, in this aspect, the ending potential for at least one cycle or the average ending potential for all of the cycles is from about 0.01 volt to about 0.5 volt, e.g., from about 0.05 volt to about 0.4 volts, from about 0.1 volt to about 0.3 volt, or about 0.2 volt.

One skilled in the art would appreciate that similar activation results may be achieved by increasing or decreasing current to the membrane electrode assembly. Further, since any increasing or decreasing of current would necessarily result in a corresponding increase or decrease in potential, such embodiments are within the purview of various embodiments of the present invention.

Conversely, in another aspect, the step of repeatedly applying an increasing or decreasing potential comprises repeatedly applying an increasing potential. In this aspect, the starting potential for at least one cycle or the average starting potential for all of the cycles preferably is from about 0.01 volt to about 0.5 volt, e.g., from about 0.05 volt to about 0.4 volts, from about 0.1 volt to about 0.3 volt, or about 0.2 volt. Preferably, in this aspect, the ending potential for at least one cycle or the average ending potential for all of the cycles is from about 0.4 volts to about 0.9 volts, e.g., from about 0.5 volts to about 0.8 volts, from about 0.6 volts to about 0.8 volts, or about 0.7 volts.

In another aspect, the step of repeatedly applying an increasing or decreasing potential comprises repeatedly applying an increasing potential and repeatedly applying a decreasing potential. In this aspect, an increasing potential is applied in at least one cycle, and a decreasing potential is applied to at least one other cycle. The repeated applications of increasing and decreasing potential may be alternated, meaning, for example, that in a first cycle the potential is increased, in a second consecutive cycle the potential is decreased, and in a third consecutive cycle the potential is increased, etc. Additionally or alternatively, multiple repeated applications of increasing potential are applied in multiple consecutive cycles and/or multiple repeated applications of decreasing potential are applied in multiple consecutive cycles.

In various optional embodiments, the rate at which the increasing or decreasing potential is increased or decreased in at least one cycle or the average rate at which the increasing or decreasing potential is increased or decreased for all of the cycles is from about 0.01 volts/minute to about 0.2 volts/minute, e.g., from about 0.05 volts/minute to about 0.15 volts/minute, and preferably about 0.1 volts/minute, as computed from the starting potential to the ending potential for the at least one cycle or all of the cycles, respectively.

Duty cycle is the proportion of time during which a component, device, or system is operated. The duty cycle can be expressed as a ratio or as a percentage. Preferably, during the activation processes of the present invention, the MEA has a duty cycle of from about 10% to about 90%, e.g., from about 20% to about 80% or from about 40% to about 60%.

Additionally, it should be noted that the increasing or decreasing potential may be increased or decreased linearly, meaning without stopping at any specific potential values as the potential is increased or decreased from the starting potential to the ending potential, or may be increased or decreased incrementally, meaning that the increasing or decreasing potential is increased or decreased from the starting potential to one or more intermediate potentials before being ultimately increased or decreased to the ending potential. In the latter aspect, the potential is held at the one or more intermediate potentials for a hold period before being further increased or decreased to another intermediate potential or the ending potential. Thus, in one aspect, the step of repeatedly applying the increasing or decreasing potential in each of a plurality of cycles comprises holding each of a series of increasing or decreasing applied potentials (intermediate potentials) for from about 1 second to about 120 seconds, e.g., from about 5 seconds to about 60 seconds, from about 15 seconds to about 45 seconds, from about 25 seconds to about 35 seconds, or about 30 seconds. In this aspect, the sequential applied potentials in the series of increasing or decreasing applied potentials for at least one cycle (and optionally for all cycles) may differ by an average potential difference (ΔV) from about 0.01 volt to about 0.1 volt, e.g., from about 0.03 volt to about 0.07 volt, or about 0.05 volt. In this context, “ΔV” means the absolute value of the difference in potential between any two sequential applied potentials in the at least one cycle, and the average ΔV is based on the ΔV between all respective sequential intermediate potentials for the at least one cycle (and, if specified, for all cycles), including differences in potential between any intermediate potentials and the starting or ending potentials for intermediate potentials that are sequential with the starting or ending potentials. Thus, as a non-limiting example, at the beginning of the application of a decreasing potential in a respective cycle, the potential may be held at, e.g., 0.7 volts for 30 seconds, then lowered to 0.65 volts for 30 seconds, then lowered to 0.6 volts for 30 seconds, and so on.

Optionally, for any of the processes of the present invention, the process includes a step of applying a substantially constant potential to the MEA, e.g., DMFC MEA, for at least 5 minutes, e.g., at least 10 minutes, at least 15 minutes, at least 20 minutes, at least 30 minutes. In this context, the term “substantially constant potential” means a potential that varies by not more than ±0.05 volt over at least 5 minutes. This step may be performed before, in between, or after the step of repeatedly applying an increasing or decreasing potential in each of the plurality of cycles over the voltage range of at least 0.1 volts, e.g., at least 0.2 volts or at least 0.3 volts. The substantially constant potential optionally comprises a specific voltage between from about 0.1 volt to about 0.7 volt, e.g., from about 0.2 volt to about 0.6 volt, from about 0.3 volts to about 0.5 volts, or about 0.4 volt.

The number of cycles necessary to achieve substantial activation will vary widely depending, for example, on the starting hydration level of the MEA as well as whether any of the cycles are organized as cycle sets, as described below, and on the applied temperature profile(s), also discussed below. The potential preferably is increased or decreased repeatedly for as many cycles as are necessary to substantially activate the MEA. As used herein, an MEA is “substantially activated” when it reaches at least 80% of its maximum achievable power density, preferably at least 85%, at least 90%, at least 95% and most preferably at least 99% of its maximum achievable power density. In various optional aspects, the potential is increased or decreased repeatedly in at least 5 cycles, at least 10 cycles, at least 15 cycles, at least 20 cycles or at least 25 cycles. In terms of ranges, the potential optionally is increased or decreased repeatedly in from about 16 to about 32 cycles, e.g., from about 20 to about 28 cycles, from about 22 to about 26 cycles, or about 24 cycles. In some exemplary embodiments, the process can be employed to activate an MEA, e.g., DMFC MEA, to a power density of at least about 120 mW/cm², at least about 130 mW/cm², at least about 150 mW/cm², or at least about 160 mW/cm². In some aspects of the present invention, the process can be used to activate an MEA such that it achieves substantial activation in less than 48 hours, e.g., 36 hours, 24 hours, 12 hours, 6 hours, 4 hours, or 2 hours. In another aspect, the process provides an increase in activation (power) of greater than about 20%, e.g., greater than about 50%, greater than about 100% or greater than about 200%, after less than about 20 hours, e.g., after less than about 15 hours, after less than 10 hours or after less than 5 hours.

In various preferred aspects of the invention, the cycles are organized in a plurality of cycle sets. As indicated above, the term “cycle set” means a plurality of sequential cycles that are not separated by any appreciable rest period (e.g., are not separated by a rest period of more than about 5 minutes). The number of cycle sets employed in the various processes of the present invention may be from about 5 to about 11 cycle sets, e.g., from about 7 to about 9 cycle sets, or from about 8 to about 9 cycle sets. It has been found that in various aspects, substantial activation may be achieved in about 7, about 8 or about 9 cycle sets. As used herein, the first cycle in a cycle set is referred to as a “starting cycle,” the last cycle in the cycle set is referred to herein as an “ending cycle,” and intervening cycles (if any) between the starting cycle and the ending cycle are referred to herein as an “intermediate cycles.”

The number of cycles included in a respective cycle set or the average number of cycles per cycle set in the overall process also may vary, but preferably is from about 2 to about 5, e.g., from about 2 to about 4, from about 2 to about 3, or specifically, about 2, about 3, or about 4 cycles.

Each respective cycle set preferably is, in turn, separated from a sequential cycle set by a rest period. The rest period between sequential cycle sets may vary widely. In various optional embodiments, the rest period between two sequential cycle sets or the average rest period of the rest periods between all sequential cycle sets in the process is less than about 24 hours, e.g., less than about 10 hours, less than about 5 hours, less than about 3 hours, less than about 2.5 hours, less than about 2 hours or less than about 2.5 hours. In terms of ranges, the rest period between two sequential cycle sets or the average rest period of the rest periods between all sequential cycle sets in the process is optionally from about 0.5 to about 24 hours, e.g., from about 0.5 to about 10 hours, from about 0.5 to about 5 hours, from about 0.5 to about 4 hours, from about 0.5 to about 3 hours, from about 1 to about 2 hours, or, specifically, about 1 hour, about 1.5 hours, or about 2 hours.

In a preferred embodiment, at least one cycle set has an increasing temperature profile. By “increasing temperature profile” it is meant that the ending temperature at which the ending cycle is run is greater than the starting temperature at which the starting cycle is run. The absolute difference in temperature between the ending temperature and the starting temperature optionally is greater than about 10° C., e.g., greater than about 15° C., greater than about 20° C., or greater than about 25° C. Preferably, cycles (including intermediate cycles, if any) in the at least one cycle set are run at increasing temperatures relative to an immediately preceding cycle in the at least one cycle set. For example, the increasing temperature profile optionally comprises an average change in temperature (ΔT) for sequential cycles in the at least one cycle set of from about 1° C. to about 20° C., e.g., from about 5° C. to about 15° C., from about 7° C. to about 13° C., or specifically about 5° C., about 10° C. or about 15° C. In one aspect, the at least one cycle set comprises a starting cycle that is run at a temperature of from about 30° C. to about 70° C. (e.g., from about 40° C. to about 60° C., from about 45° C. to about 55° C., or about 50° C.), and an ending cycle that is run at a temperature of from about 50° C. to about 90° C. (e.g., from about 60° C. to about 80° C., from about 65° C. to about 75° C., or about 70° C.).

Conversely, in another embodiment, at least one cycle set has a decreasing temperature profile. By “decreasing temperature profile” it is meant that the ending temperature at which the ending cycle is run is less than the starting temperature at which the starting cycle is run. The absolute difference in temperature between the ending temperature and the starting temperature optionally is greater than about 10° C., e.g., greater than about 15° C., greater than about 20° C., or greater than about 25° C. Preferably, cycles (including intermediate cycles, if any) in the at least one cycle set are run at decreasing temperatures relative to an immediately preceding cycle in the at least one cycle set. For example, the decreasing temperature profile optionally comprises an average change in temperature (average ΔT) for sequential cycles in the at least one cycle set of from about 1° C. to about 20° C., e.g., from about 5° C. to about 15° C., from about 7° C. to about 13° C., or specifically about 5° C., about 10° C. or about 15° C. In one aspect, the at least one cycle set comprises a starting cycle that is run at a temperature of from about 50° C. to about 90° C. (e.g., from about 60° C. to about 80° C., from about 65° C. to about 75° C., or about 70° C.), and an ending cycle that is run at a temperature of from about 30° C. to about 70° C. (e.g., from about 40° C. to about 60° C., from about 45° C. to about 55° C., or about 50° C.).

In some embodiments, all cycles in at least one cycle set and/or all cycles in the overall process are performed at a substantially constant temperature, e.g., a substantially constant elevated temperature. In this aspect, the substantially constant temperature optionally is in the range of from about 30° C. to about 90° C., e.g., from about 40° C. to about 80° C., from about 50° C. to about 70° C., from about 50° C. to about 60° C., or from about 60° C. to about 70° C.

In another aspect, the process comprises a plurality of cycle sets, and each cycle set is run at a substantially constant temperature, which varies between sequential cycle sets. As a non-limiting example, the process may include a first cycle set run at a first substantially constant temperature, a second cycle set run at a second substantially constant temperature, a third cycle set run at a third substantially constant temperature, and so on. In this aspect of the invention, the temperature profile from cycle set to cycle set may increase, decrease, or both. Optionally, the cycle sets (including intermediate cycles sets, if any) in the process are run at increasing and/or decreasing temperatures relative to an immediately preceding cycle set. For example, the temperature profile (whether increasing and/or decreasing) optionally comprises an average change in temperature (average ΔT) for sequential cycle sets in the process of from about 1° C. to about 20° C., e.g., from about 5° C. to about 15° C., from about 7° C. to about 13° C., or specifically about 5° C., about 10° C. or about 15° C. In one aspect, the process comprises a starting cycle set that is run at a substantially constant temperature of from about 50° C. to about 90° C. (e.g., from about 60° C. to about 80° C., from about 65° C. to about 75° C., or about 70° C.), and an ending cycle set that is run at a substantially constant temperature of from about 30° C. to about 70° C. (e.g., from about 40° C. to about 60° C., from about 45° C. to about 55° C., or about 50° C.). Conversely, in another aspect, the process comprises a starting cycle set that is run at a substantially constant temperature of from about 30° C. to about 70° C. (e.g., from about 40° C. to about 60° C., from about 45° C. to about 55° C., or about 50° C.), and an ending cycle set that is run at a substantially constant temperature of from about 50° C. to about 90° C. (e.g., from about 60° C. to about 80° C., from about 65° C. to about 75° C., or about 70° C.).

Optionally, for any of the processes of the present invention, the process includes a step of applying a pulsed potential to the MEA, e.g., DMFC MEA, for at least 10 seconds, e.g., at least 30 seconds, at least 1 minute, at least 5 minutes, at least 10 minutes, at least 15 minutes, at least 20 minutes, or at least 30 minutes. By “pulsed” it is meant that two different potentials (referred to herein as a first potential and a second potential) are applied in an alternating manner to the MEA, which alternating potentials are not separated by any appreciable rest periods. This step may be performed before, in between, or after the step of repeatedly applying an increasing or decreasing potential in each of the plurality of cycles over the voltage range of at least 0.1 volts, e.g., at least 0.2 volts or at least 0.3 volts. The pulsed potential optionally is pulsed between a first potential of from about 0.1 volt to about 0.5 volt (e.g., from about 0.2 volt to about 0.4 volt, or about 0.3 volt) and a second potential of from about 0.5 volt to about 0.8 volt (e.g., from about 0.6 volt to about 0.8 volt, or about 0.7 volt).

### III. EXAMPLES

The present invention will be further illustrated by the following non-limiting examples.

### Example 1

### Method for Activation of DMFC MEA with Hydrogen

A 25 cm² active area MEA was fed with deionized (DI) water from the cathode to the anode by circulating the DI water through the MEA at a rate of 1 mL/min at room temperature for about 10 minutes. The feeding of the MEA with water was then stopped. The anode of the MEA was then supplied with humidified hydrogen gas (humidifier temperature 80° C.) at a rate of 150 standard cubic centimeters per minute (sccm). Concurrently, the cathode of the MEA was supplied with humidified air (humidifier temp. 80° C.) at a rate of 460 sccm with or without 30 psig back pressures on both the anode and cathode sides of the MEA. During this time the MEA temperature was maintained at 80° C.

A constant voltage of 0.4 volts was then applied to the MEA and the current change was monitored. Optionally, the voltage can be pulsed between 0.4 volts and 0.6 volts for 20 seconds at each potential. After about 5 to 10 minutes of holding the voltage across the cell at 0.4 volts, there was a significant increase in the MEA current reflecting an increase in activation. The hydrogen flow was stopped and the MEA was allowed to cool to 70° C. Then, methanol was fed into the anode (e.g., 1 M in water, at a rate of 1-3 mL/min), while humidified air was continued to be fed into the cathode. At this time, the potential of the MEA was decreased from 0.7 volts to 0.2 volts in 0.05 volt increments and holding at each voltage step for 30 seconds. In other words, the voltage was decreased at a rate of 0.10 volts/minute. The MEA was then allowed to cool to 60° C. At this time, the potential of the MEA was decreased from 0.7 volts to 0.2 volts while the MEA was kept at 60° C. The MEA was then allowed to cool to 50° C. At this time, the potential of the MEA was decreased from 0.7 volts to 0.2 volts while the MEA was kept at 50° C. The voltage and power density for the MEA as a function of current density was determined throughout each scan. The MEA was off-loaded for about two hours and the MEA was allowed to cool to room temperature (i.e., approximately 25° C.) prior to beginning the second cycle set. As used herein, the term “off-loaded” means that the methanol/air source and electric wires were disconnected from the MEA.

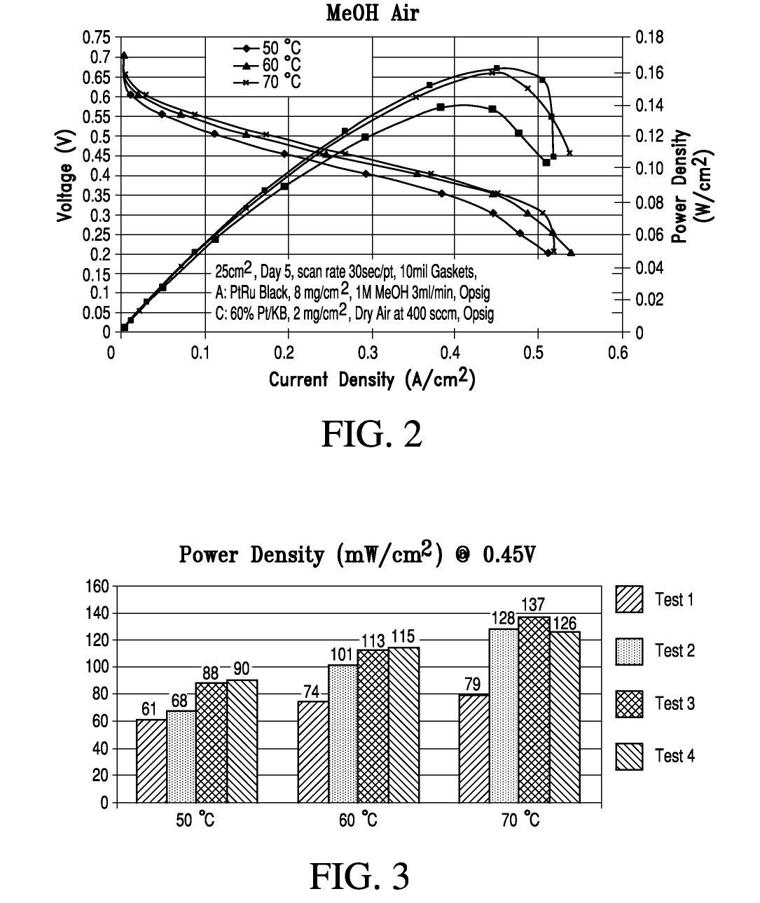

The MEA was cycled through the decrease in potential (0.7 volts to 0.2 volts) at the three different temperatures (50° C., 60° C., and 70° C.) and off-load periods for three additional cycle sets. During the fourth cycle set, the voltage and the power density for the MEA were plotted as a function of current density at each temperature to provide the plot shown in FIG. 2. The values for power density at 0.45 volts during each cycle are shown graphically in FIG. 3.

### Example 2

### Method of Activation of DMFC MEA Without Hydrogen Gas

An MEA was fed with DI water from the cathode to the anode by circulating the DI water through the MEA at a rate of 1 mL/min at room temperature for about 10 minutes. The feeding of the MEA with water was then stopped. The cathode of the MEA was then supplied with humidified air (humidifier temp. 80° C.) at a rate of 460 sccm. Methanol was fed into the anode (e.g., 1 M in water, at a rate of 1-3 mL/min) and the MEA temperature was brought to 70° C. At this time, the potential of the MEA was decreased from 0.7 volts to 0.2 volts in 0.05 volts steps and holding at each voltage step for 30 seconds. The MEA was allowed to cool to 60° C. At this time, the potential of the MEA was decreased from 0.7 volts to 0.2 volts while the MEA was kept at 60° C. Once the potential had been decreased to 0.2 volts, the power density of the MEA at 0.45 volts was measured and recorded. The MEA was then allowed to cool to 50° C. At this time, the potential of the MEA was decreased from 0.7 volts to 0.2 volts while the MEA was kept at 50° C. The MEA was off-loaded for about two hours and the MEA was allowed to cool to room temperature (i.e., approximately 25° C.) prior to beginning the second cycle set. The voltage and power density for the MEA as a function of current density was determined throughout each scan.

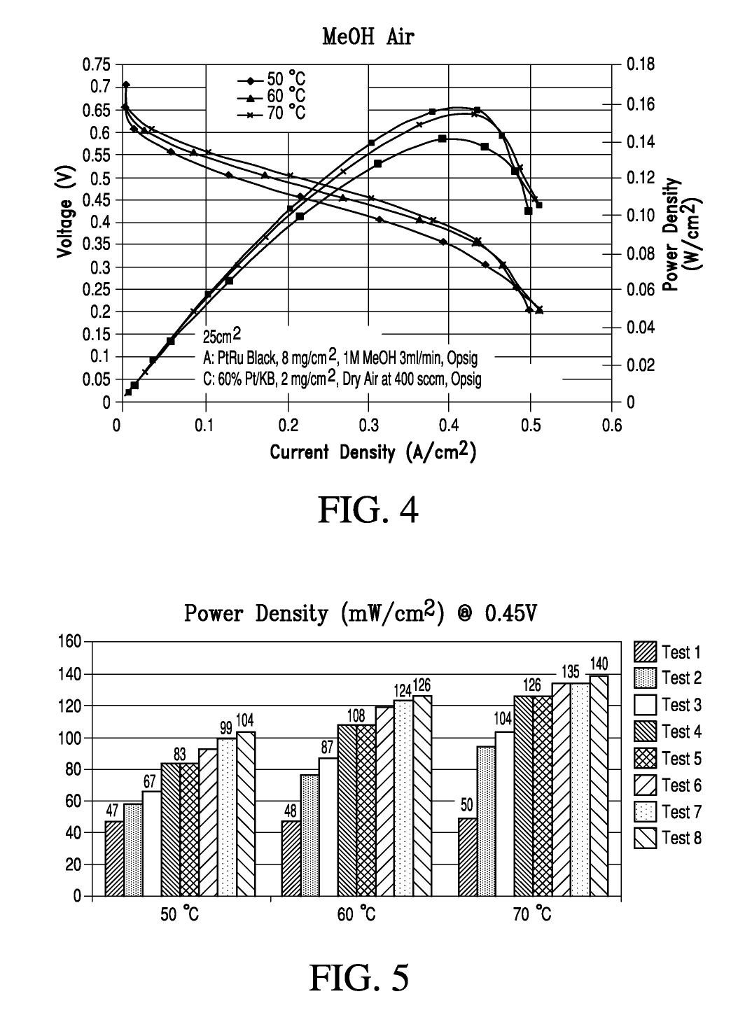

The MEA was cycled through the decrease in potential (0.7 volts to 0.2 volts) at the three different temperatures (50° C., 60° C., and 70° C.) and off-load periods for seven additional cycle sets. During each cycle the voltage and power density of the MEA was measured over the range 0.7 to 0.2 volts and recorded (See FIG. 4). The values for power density at 0.45 volts for each cycle set as a function of temperature are shown graphically in FIG. 5.

It is clear from the example described above that an MEA can be activated, without the use of hydrogen gas, to an extent that is comparable or that surpasses activation processes that use hydrogen gas.

### Example 3

### Method of Activation of DMFC MEA Without Hydrogen Gas—Holding Voltage Constant Before Each Cycle Set

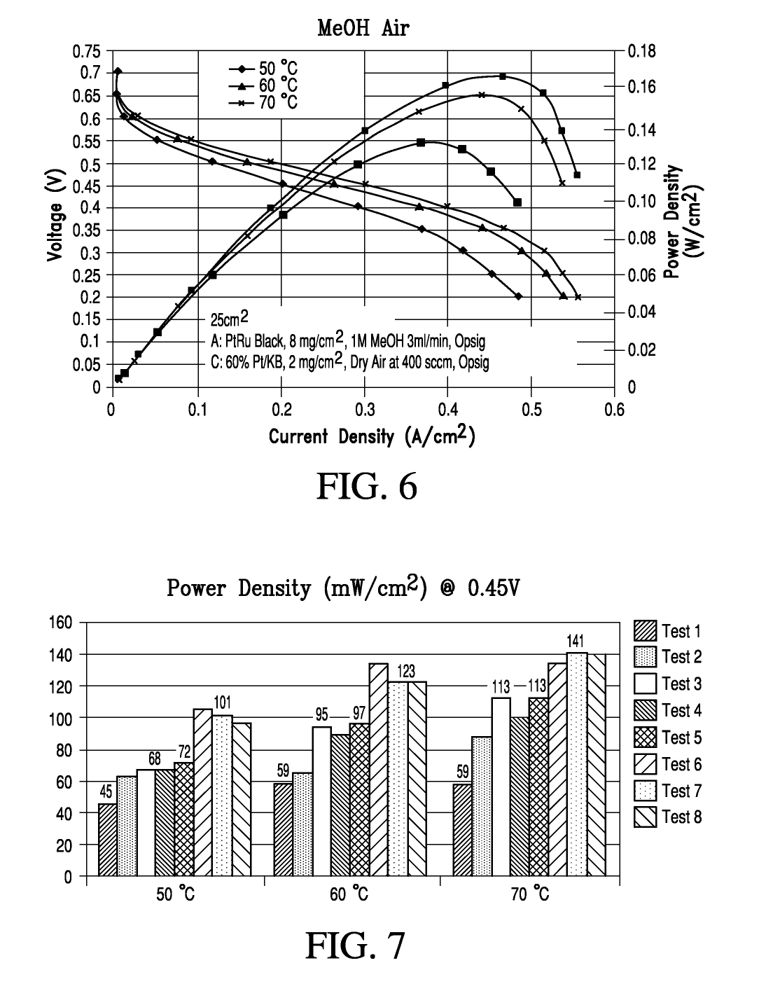

The MEA was set up as it was in Example 2. But, before the first cycle set and before each subsequent cycle set, the MEA was brought to 70° C. and the voltage was held at 0.4 volts for 30 minutes. The MEA was then cycled through the decrease in potential (0.7 volts to 0.2 volts) at three different temperatures (50° C., 60° C., and 70° C.), including off-load periods, through a total of eight cycle sets. The voltage and power density for the MEA as a function of current density was determined throughout each scan. During each cycle the power density of the MEA was measured over the range 0.7 to 0.2 volts, and recorded (See FIG. 6). The values for power density at 0.45 volts for each cycle set as a function of temperature are shown graphically in FIG. 7.

### Example 4

### Method of Activation of DMFC MEA Without Hydrogen Gas—Pulsing Voltage Before Each Cycle Set

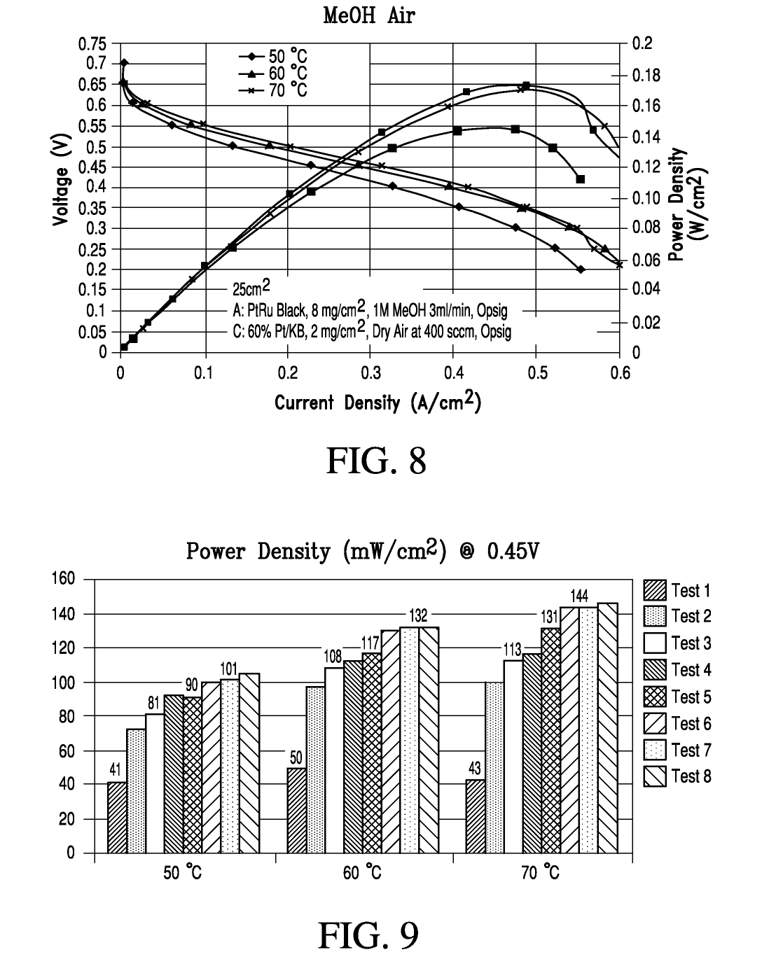

The MEA was set up as it was in Example 2. But, before the first cycle set and before each subsequent cycle set, the MEA was brought to 70° C. and the voltage was pulsed between 0.4 volts and 0.6 volts and held at each voltage for 1 minute. The pulsing of the potential was done over a 30 minute period. After the 30 minute period, the MEA was cycled through the decrease in potential (0.7 volts to 0.2 volts) at three different temperatures (50° C., 60° C., and 70° C.), including off-load periods, through a total of eight cycle sets. During each cycle the power density of the MEA was measured over the range 0.7 to 0.2 volts, and recorded (See FIG. 8). The values for power density at 0.45 volts for each cycle set as a function of temperature are shown graphically in FIG. 9.

### Example 5

### Exemplary Protocol for Activating a DMFC MEA with Methanol and Air

A dry non-hydrated 50 cm² MEA is set at a cell temperature of 50° C. 0.5 M Methanol solution is then fed to the anode at 5 mL/min and humidified air (at 77° C.) is fed to the cathode at 400 sccm. Cell voltage is then set at 0.40 V and current is monitored. Once current stabilizes (stops increasing) a polarization curve is run from 0.7 to 0.2 V with a scan rate of 0.05 V per 20 seconds. Anode and cathode flows should then be stopped after the polarization curve has completed.

The MEA is then set at a cell temperature of 60° C. Methanol and air are again fed to the MEA, as described above. The cell is then set to open circuit voltage (current set to 0), and the voltage is monitored. Once voltage stops increasing, the cell should be set to 0.4 V and current monitored. Once the current is stable (stops increasing), a polarization curve is run from 0.7 to 0.2 V with a scan rate of 0.05 V per 20 seconds. Anode and cathode flows are stopped after the polarization curve is completed. The steps in this paragraph should be repeated, but at a cell temperatures of 70° C. and then 80° C. After completing the 80° C. cycle, the cell should be allowed to cool down to room temperature and then sit for a minimum rest period of 2-3 hours. The steps in this paragraph (cycles at 60° C., 70° C. and 80° C.) then should be repeated after the rest period.

Then, the cell should be tested to determine if substantial activation has been achieved. If substantial activation has not yet been achieved, the cycle set (comprising cycles at 60° C., 70° C. and 80° C.) and rest period described in the preceding paragraph should be repeated again, followed by testing to determine if substantial activation has been obtained. In this manner, the cycle set is repeated, separated by rest periods, as many times as necessary to achieve substantial activation.

It is noted that the foregoing examples have been provided merely for the purpose of explanation and are in no way to be construed as limiting of the present invention. While the present invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

What is claimed is:

1. A process for activating a membrane electrode assembly, comprising repeatedly applying an increasing or decreasing potential in each of a plurality of cycles over a voltage range of at least 0.1 volts while feeding a hydrocarbon fuel and an oxidant to the membrane electrode assembly until the membrane electrode assembly is substantially activated.

2. The process of claim 1, wherein at least two of the plurality of cycles are separated by a rest period of less than 10 hours.

3. The process of claim 1, wherein at least two of the plurality of cycles are separated by a rest period of less than 3 hours.

4. The process of claim 1, wherein the hydrocarbon fuel comprises an alkanol fuel.

5. The process of claim 4, wherein the alkanol fuel comprises methanol.

6. The process of claim 1, wherein the feeding comprises feeding air to the membrane electrode assembly, wherein the air has a relative humidity of less than about 40%.

7. The process of claim 1, wherein the feeding comprises feeding air to the membrane electrode assembly, and wherein the air pressure is less than about 800 torr.

8. The process of claim 1, wherein the plurality of cycles is organized in a plurality of cycle sets.

9. The process of claim 8, wherein the plurality of cycle sets comprises from about 5 cycle sets to about 11 cycle sets.

10. The process of claim 8, wherein the plurality of cycle sets comprises from about 7 cycle sets to about 9 cycle sets.

11. The process of claim 8, wherein the plurality of cycle sets has an average number of cycles per cycle set of from about 2 to about 4.

12. The process of claim 8, wherein at least one cycle set has an increasing temperature profile for each respective cycle in the at least one cycle set.

13. The process of claim 12, wherein the increasing temperature profile comprises an average ΔT for sequential cycles in the at least one cycle set of from about 5° C. to about 15° C.

14. The process of claim 12, wherein the at least one cycle set comprises a starting cycle that is run at a temperature of from about 40° C. to about 60° C., and an ending cycle that is run at a temperature of from about 60° C. to about 80° C.

15. The process of claim 8, wherein at least one cycle set has a decreasing temperature profile for each respective cycle in the at least one cycle set.

16. The process of claim 15, wherein the decreasing temperature profile comprises an average ΔT for adjacent cycles in the at least one cycle set of from about 5° C. to about 15° C.

17. The process of claim 15, wherein the at least one cycle set comprises a starting cycle that is run at a temperature of from about 60° C. to about 80° C., and an ending cycle that is run at a temperature of from about 40° C. to about 60° C.

18. The process of claim 8, wherein the plurality of cycle sets are separated by an average rest period of less than about 24 hours.

19. The process of claim 8, wherein the plurality of cycle sets are separated by an average rest period of less than about 10 hours.

20. The process of claim 8, wherein the plurality of cycle sets are separated by an average rest period of less than about 5 hours.

21. The process of claim 1, wherein the application of the increasing or decreasing potential is over a voltage range of at least 0.4 volts.

22. The process of claim 1, wherein the application of the increasing or decreasing potential is over a voltage range of at least 0.5 volts.

23. The process of claim 1, wherein the increasing or decreasing potential comprises an increasing potential.

24. The process of claim 23, wherein in at least one cycle, the application of the increasing potential begins at a starting potential that is from about 0.1 volts to about 0.3 volts.

25. The process of claim 24, wherein in the at least one cycle, the application of the increasing potential ends at an ending potential that is from about 0.5 volts to about 0.8 volts.

26. The process of claim 23, wherein in the at least one cycle, the application of the increasing potential ends at an ending potential that is from about 0.5 volts to about 0.8 volts.

27. The process of claim 1, wherein the increasing or decreasing potential comprises a decreasing potential.

28. The process of claim 27, wherein in at least one cycle, the application of the decreasing potential begins at a starting potential that is from about 0.5 volts to about 0.8 volts.

29. The process of claim 28, wherein in the at least one cycle, the application of the decreasing potential ends at an ending potential that is from about 0.1 volts to about 0.3 volts.

30. The process of claim 27, wherein in at least one cycle, the application of the decreasing potential ends at an ending potential that is from about 0.1 volts to about 0.3 volts.

31. The process of claim 1, wherein the membrane electrode assembly is substantially activated in less than about 48 hours.

32. The process of claim 1, wherein the membrane electrode assembly is substantially activated in less than about 24 hours.

33. The process of claim 1, wherein the process provides an increase in activation of greater than about 20%, after less than about 20 hours.

34. The process of claim 1, wherein the process provides an increase in activation of greater than about 100%, after less than about 20 hours.

35. The process of claim 1, wherein the increasing or decreasing potential is increased or decreased at a rate from about 0.05 volts/minute to about 0.15 volts/minute.

36. The process of claim 1, wherein the step of repeatedly applying the increasing or decreasing potential in each of a plurality of cycles comprises:
holding each of a series of increasing or decreasing applied potentials in at least one cycle for from about 15 seconds to about 45 seconds.

37. The process of claim 36, wherein sequential applied potentials in the series of increasing or decreasing applied potentials in the at least one cycle differ by an average ΔV of from about 0.01 volt to about 0.1 volt.

38. The process of claim 36, wherein sequential applied potentials in the series of increasing or decreasing applied potentials in all cycles differ by an average ΔV of from about 0.01 volt to about 0.1 volt.

39. The process of claim 1, wherein the process further comprises applying a substantially constant potential to the membrane electrode assembly for at least 15 minutes.

40. The process of claim 39, wherein the substantially constant potential comprises a specific voltage between from about 0.3 volts to about 0.5 volts.

41. The process of claim 40, wherein the substantially constant potential is applied before the step of repeatedly applying the increasing or decreasing potential.

42. The process of claim 40, wherein the substantially constant potential is applied after the step of repeatedly applying the increasing or decreasing potential.

43. The process of claim 1, wherein the process further comprises applying a pulsed potential to the membrane electrode assembly for at least 5 minutes.

44. The process of claim 43, wherein the pulsed potential is pulsed between a first potential of from about 0.1 volt to about 0.5 volt and a second potential of from about 0.5 volt to about 0.8 volt.

45. The process of claim 44, wherein the pulsed potential is applied before the step of repeatedly applying the increasing or decreasing potential.

46. The process of claim 44, wherein the pulsed potential is applied after the step of repeatedly applying the increasing or decreasing potential.

47. A process for activating a membrane electrode assembly, comprising repeatedly applying an increasing or decreasing potential in each of a plurality of cycles over a voltage range of at least 0.1 volts until the membrane electrode assembly is substantially activated, wherein at least two of the plurality of cycles are separated by a rest period of less than 10 hours.

48. The process of claim 47, wherein at least two of the plurality of cycles are separated by a rest period of less than 3 hours.

49. The process of claim 47, further comprising providing a hydrocarbon fuel and air to the membrane electrode assembly during the application of the increasing or decreasing potential.

50. The process of claim 49, wherein the hydrocarbon fuel comprises an alkanol fuel.

51. The process of claim 50, wherein the alkanol fuel comprises methanol.

52. The process of claim 49, wherein the air has a relative humidity of less than about 40%.

53. The process of claim 49, wherein the providing comprises providing the hydrocarbon fuel at a pressure of less than about 800 torr.

54. The process of claim 47, wherein the plurality of cycles is organized in a plurality of cycle sets.

55. The process of claim 54, wherein the plurality of cycle sets comprises from about 5 cycle sets to about 11 cycle sets.

56. The process of claim 54, wherein the plurality of cycle sets comprises from about 7 cycle sets to about 9 cycle sets.

57. The process of claim 54, wherein the plurality of cycle sets has an average number of cycles per cycle set of from about 2 to about 4.

58. The process of claim 54, wherein at least one cycle set has an increasing temperature profile for each respective cycle in the at least one cycle set.

59. The process of claim 58, wherein the increasing temperature profile comprises an average ΔT for sequential cycles in the at least one cycle set of from about 5° C. to about 15° C.

60. The process of claim 58, wherein the at least one cycle set comprises a starting cycle that is run at a temperature of from about 40° C. to about 60° C., and an ending cycle that is run at a temperature of from about 60° C. to about 80° C.

61. The process of claim 54, wherein at least one cycle set has a decreasing temperature profile for each respective cycle in the at least one cycle set.

62. The process of claim 61, wherein the decreasing temperature profile comprises an average ΔT for adjacent cycles in the at least one cycle set of from about 5° C. to about 15° C.

63. The process of claim 61, wherein the at least one cycle set comprises a starting cycle that is run at a temperature of from about 60° C. to about 80° C., and an ending cycle that is run at a temperature of from about 40° C. to about 60° C.

64. The process of claim 54, wherein the plurality of cycle sets are separated by an average rest period of less than about 24 hours.

65. The process of claim 54, wherein the plurality of cycle sets are separated by an average rest period of less than about 10 hours.

66. The process of claim 54, wherein the plurality of cycle sets are separated by an average rest period of less than about 5 hours.

67. The process of claim 47, wherein the application of the increasing or decreasing potential is over a voltage range of at least 0.4 volts.

68. The process of claim 47, wherein the application of the increasing or decreasing potential is over a voltage range of at least 0.5 volts.

69. The process of claim 47, wherein the increasing or decreasing potential comprises an increasing potential.

70. The process of claim 47, wherein the increasing or decreasing potential comprises a decreasing potential, and wherein in at least one cycle, the application of the decreasing potential begins at a starting potential that is from about 0.5 volts to about 0.8 volts.

71. The process of claim 70, wherein in the at least one cycle, the application of the decreasing potential ends at an ending potential that is from about 0.1 volts to about 0.3 volts.

72. The process of claim 47, wherein the increasing or decreasing potential comprises a decreasing potential, and wherein in at least one cycle, the application of the decreasing potential ends at an ending potential that is from about 0.1 volts to about 0.3 volts.

73. The process of claim 47, wherein the membrane electrode assembly is substantially activated in less than about 48 hours.

74. The process of claim 47, wherein the membrane electrode assembly is substantially activated in less than about 24 hours.

75. The process of claim 47, wherein the process provides an increase in activation of greater than about 20%, after less than about 20 hours.

76. The process of claim 47, wherein the process provides an increase in activation of greater than about 100%, after less than about 20 hours.

77. The process of claim 47, wherein the increasing or decreasing potential is increased or decreased at a rate from about 0.05 volts/minute to about 0.15 volts/minute.

78. The process of claim 47, wherein the step of repeatedly applying the increasing or decreasing potential in each of a plurality of cycles comprises:
holding each of a series of increasing or decreasing applied potentials in at least one cycle for from about 15 seconds to about 45 seconds.

79. The process of claim 78, wherein sequential applied potentials in the series of increasing or decreasing applied potentials in the at least one cycle differ by an average ΔV of from about 0.01 volt to about 0.1 volt.

80. The process of claim 79, wherein sequential applied potentials in the series of increasing or decreasing applied potentials in all cycles differ by an average ΔV of from about 0.01 volt to about 0.1 volt.

81. The process of claim 47, wherein the process further comprises applying a substantially constant potential to the membrane electrode assembly for at least 15 minutes.

82. The process of claim 81, wherein the substantially constant potential comprises a specific voltage between from about 0.3 volts to about 0.5 volts.

83. The process of claim 82, wherein the substantially constant potential is applied before the step of repeatedly applying the increasing or decreasing potential.

84. The process of claim 82, wherein the substantially constant potential is applied after the step of repeatedly applying the increasing or decreasing potential.

85. The process of claim 47, wherein the process further comprises applying a pulsed potential to the membrane electrode assembly for at least 5 minutes.

86. The process of claim 85, wherein the pulsed potential is pulsed between a first potential of from about 0.1 volt to about 0.5 volt and a second potential of from about 0.5 volt to about 0.8 volt.

87. The process of claim 86, wherein the pulsed potential is applied before the step of repeatedly applying the increasing or decreasing potential.

88. The process of claim 86, wherein the pulsed potential is applied after the step of repeatedly applying the increasing or decreasing potential.

89. A process for activating a membrane electrode assembly, comprising repeatedly applying an increasing or decreasing potential in each of a plurality of cycles over a voltage range of at least 0.1 volts until the membrane electrode assembly is substantially activated, wherein the cycles are organized in a plurality of cycle sets separated by an average rest period of less than about 24 hours.

90. The process of claim 89, further comprising providing a hydrocarbon fuel and air to the membrane electrode assembly during the application of the increasing or decreasing potential.

91. The process of claim 90, wherein the hydrocarbon fuel comprises an alkanol fuel.

92. The process of claim 91, wherein the alkanol fuel comprises methanol.

93. The process of claim 90, wherein the air has a relative humidity of less than about 40%.

94. The process of claim 90, wherein the providing comprises providing the hydrocarbon fuel at a pressure of less than about 800 torr.

95. The process of claim 89, wherein the plurality of cycle sets comprises from about 5 cycle sets to about 11 cycle sets.

96. The process of claim 89, wherein the plurality of cycle sets comprises from about 7 cycle sets to about 9 cycle sets.

97. The process of claim 89, wherein the plurality of cycle sets has an average number of cycles per cycle set of from about 2 to about 4.

98. The process of claim 89, wherein at least one cycle set has an increasing temperature profile for each respective cycle in the at least one cycle set.

99. The process of claim 98, wherein the increasing temperature profile comprises an average ΔT for sequential cycles in the at least one cycle set of from about 5° C. to about 15° C.

100. The process of claim 98, wherein the at least one cycle set comprises a starting cycle that is run at a temperature of from about 40° C. to about 60° C., and an ending cycle that is run at a temperature of from about 60° C. to about 80° C.

101. The process of claim 89, wherein at least one cycle set has a decreasing temperature profile for each respective cycle in the at least one cycle set.

102. The process of claim 101, wherein the decreasing temperature profile comprises an average ΔT for adjacent cycles in the at least one cycle set of from about 5° C. to about 15° C.

103. The process of claim 101, wherein the at least one cycle set comprises a starting cycle that is run at a temperature of from about 60° C. to about 80° C., and an ending cycle that is run at a temperature of from about 40° C. to about 60° C.

104. The process of claim 89, wherein the plurality of cycle sets are separated by an average rest period of less than about 10 hours.

105. The process of claim 89, wherein the plurality of cycle sets are separated by an average rest period of less than about 5 hours.

106. The process of claim 89, wherein the plurality of cycle sets are separated by an average rest period of less than about 3 hours.

107. The process of claim 89, wherein the application of the increasing or decreasing potential is over a voltage range of at least 0.4 volts.

108. The process of claim 89, wherein the application of the increasing or decreasing potential is over a voltage range of at least 0.5 volts.

109. The process of claim 89, wherein the increasing or decreasing potential comprises an increasing potential.

110. The process of claim 89, wherein the increasing or decreasing potential comprises a decreasing potential, and wherein in at least one cycle, the application of the decreasing potential begins at a starting potential that is from about 0.5 volts to about 0.8 volts.

111. The process of claim 110, wherein in the at least one cycle, the application of the decreasing potential ends at an ending potential that is from about 0.1 volts to about 0.3 volts.

112. The process of claim 89, wherein the increasing or decreasing potential comprises a decreasing potential, and wherein in at least one cycle, the application of the decreasing potential ends at an ending potential that is from about 0.1 volts to about 0.3 volts.

113. The process of claim 89, wherein the membrane electrode assembly is substantially activated in less than about 48 hours.

114. The process of claim 89, wherein the membrane electrode assembly is substantially activated in less than about 24 hours.

115. The process of claim 89, wherein the process provides an increase in activation of greater than about 20%, after less than about 20 hours.

116. The process of claim 89, wherein the process provides an increase in activation of greater than about 100%, after less than about 20 hours.

117. The process of claim 89, wherein the increasing or decreasing potential is decreased at a rate from about 0.05 volts/minute to about 0.15 volts/minute.

118. The process of claim 89, wherein the step of repeatedly applying the increasing or decreasing potential in each of a plurality of cycles comprises:
holding each of a series of increasing or decreasing applied potentials for from about 15 seconds to about 45 seconds.

119. The process of claim 89, wherein the step of repeatedly applying the increasing or decreasing potential in each of a plurality of cycles comprises:
holding each of a series of increasing or decreasing applied potentials in at least one cycle for from about 15 seconds to about 45 seconds.

120. The process of claim 119, wherein sequential applied potentials in the series of increasing or decreasing applied potentials in the at least one cycle differ by an average ΔV of from about 0.01 volt to about 0.1 volt.

121. The process of claim 119, wherein sequential applied potentials in the series of increasing or decreasing applied potentials in all cycles differ by an average ΔV of from about 0.01 volt to about 0.1 volt.

122. The process of claim 89, wherein the process further comprises applying a substantially constant potential to the membrane electrode assembly for at least 15 minutes.

123. The process of claim 122, wherein the substantially constant potential comprises a specific voltage between from about 0.3 volts to about 0.5 volts.

124. The process of claim 123, wherein the substantially constant potential is applied before the step of repeatedly applying the increasing or decreasing potential.

125. The process of claim 123, wherein the substantially constant potential is applied after the step of repeatedly applying the increasing or decreasing potential.

126. The process of claim 89, wherein the process further comprises applying a pulsed potential to the membrane electrode assembly for at least 5 minutes.

127. The process of claim 126, wherein the pulsed potential is pulsed between a first potential of from about 0.1 volt to about 0.5 volt and a second potential of from about 0.5 volt to about 0.8 volt.

128. The process of claim 127, wherein the pulsed potential is applied before the step of repeatedly applying the increasing or decreasing potential.

129. The process of claim 127, wherein the pulsed potential is applied after the step of repeatedly applying the increasing or decreasing potential.
